(19) United States
(12) Patent Application Publication
(10) Pub. No.: US 2026/0112101 A1
(43) Pub. Date: Apr. 23, 2026

(54) METHOD AND APPARATUS FOR CONTENT RENDERING, DEVICE, COMPUTER-READABLE STORAGE MEDIUM AND PRODUCT

(71) Applicants: Beijing Zitiao Network Technology Co., Ltd., Beijing (CN); Lemon Inc., Grand Cayman (KY)

(72) Inventors: Lin MA, Beijing (CN); Seth PENDERGRASS, Los Angeles, CA (US); Haoyang YE, Beijing (CN); Xuekun XIANG, Beijing (CN); Bangbang YANG, Beijing (CN); Yuewen MA, Beijing (CN)

(21) Appl. No.: 19/364,696

(22) Filed: Oct. 21, 2025

(30) Foreign Application Priority Data
Oct. 21, 2024 (CN) 202411472542.9

(51) Int. Cl. G06T 15/00; G06F 3/01; G06T 7/50

(52) U.S. Cl. CPC G06T 15/005; G06F 3/013; G06T 7/50; G06T 2207/10028

(57) ABSTRACT

Embodiments of the present disclosure provide a method and apparatus for content rendering, a device, a medium and a product. The method includes: obtaining a point cloud group to be rendered; for respective Gaussian spheres, determining a projection matrix of the Gaussian spheres in a binocular camera coordinate system corresponding to a virtual reality device; for respective pixel points in the projection area, determining a target area in the screen space corresponding to the pixel points; determining attenuation coefficients of the Gaussian spheres in the target area based on a rendering resolution corresponding to the target area, a rendering resolution corresponding to the gaze area and the projection matrix; determining rendering parameters of the pixel points according to the attenuation coefficients and color information corresponding to the Gaussian spheres, and performing a rendering operation on the pixel points based on the rendering parameters.

### CROSS-REFERENCE TO RELATED APPLICATION(S)

This application claims priority to Chinese Application No. 202411472542.9 filed Oct. 21, 2024, the disclosure of which is incorporated herein by reference in its entirety.

### FIELD

Embodiments of the present disclosure generally relate to the field of virtual reality technology, and more specifically, to method and apparatus for content rendering, device, computer-readable storage medium and product.

### BACKGROUND

As mobile devices and virtual reality all-in-one devices get popularized, how to render high-fidelity 3D scenes in real time has become an urgent problem to be solved.

3D Gaussian Splatting (3DGS for short) can reconstruct and render high-fidelity scenes. The rasterized lines are utilized during the rendering process, to greatly improve the rendering efficiency and provide basis for the real-time and high-fidelity rendering of the 3D scenes on the all-in-one VR equipment.

However, when the rendering of the 3D scene is implemented by the above method, the rendering operation on the scene-level data on the mobile device and the all-in-one virtual reality equipment usually leads to high performance pressure and low rendering efficiency as the rendering speed is positively correlated with the number of Gaussian points of the 3DGS.

### SUMMARY

Embodiments of the present disclosure provide a method and apparatus for content rendering, a device, a computer-readable storage medium and a product.

According to a first aspect, there is provided a method for content rendering, including:
obtaining a point cloud group to be rendered, the point cloud group including a plurality of Gaussian spheres characterizing a three-dimensional Gaussian distribution;
for respective Gaussian spheres, determining a projection matrix of the Gaussian spheres in a binocular camera coordinate system corresponding to a virtual reality device, the projection matrix being used for characterizing a projection area of the Gaussian spheres on a screen space corresponding to the virtual reality device;
for respective pixel points in the projection area, determining a target area in the screen space corresponding to the pixel points, wherein the screen space includes a plurality of areas partitioned based on a target gaze point and the areas include a gaze area and at least one edge area, the edge area having a rendering resolution less than the gaze area;
determining attenuation coefficients of the Gaussian spheres in the target area based on a rendering resolution corresponding to the target area, a rendering resolution corresponding to the gaze area and the projection matrix;
determining rendering parameters of the pixel points according to the attenuation coefficients and color information corresponding to the Gaussian spheres, and performing a rendering operation on the pixel points based on the rendering parameters.

According to a second aspect, embodiments of the present disclosure provide an apparatus for content rendering, including:
an obtaining module configured to obtain a point cloud group to be rendered, the point cloud group including a plurality of Gaussian spheres characterizing a three-dimensional Gaussian distribution;
a determining module configured to determine, for respective Gaussian spheres, a projection matrix of the Gaussian spheres in a binocular camera coordinate system corresponding to a virtual reality device, the projection matrix being used for characterizing a projection area of the Gaussian spheres on a screen space corresponding to the virtual reality device;
a processing module configured to determine, for respective pixel points in the projection area, a target area in the screen space corresponding to the pixel points, wherein the screen space includes a plurality of areas partitioned based on a target gaze point and the areas include a gaze area and at least one edge area, the edge area having a rendering resolution less than the gaze area;
a calculating module configured to determine attenuation coefficients of the Gaussian spheres in the target area based on a rendering resolution corresponding to the target area, a rendering resolution corresponding to the gaze area and the projection matrix;
a rendering module configured to determine rendering parameters of the pixel points according to the attenuation coefficients and color information corresponding to the Gaussian spheres, and perform a rendering operation on the pixel points based on the rendering parameters.

According to a third aspect, embodiments of the present disclosure provide an electronic device, including: a processor and a memory;
wherein the memory is stored with computer-executable instructions;
the processor executes computer-executable instructions stored in the memory, such that the at least one processor performs the method for content rendering according to the first aspect and various possible designs of the first aspect.

According to a fourth aspect, embodiments of the present disclosure provide a computer-readable storage medium stored with computer-executable instructions, wherein the computer-executable instructions, when executed by a processor, implement the method for content rendering according to the first aspect and various possible designs of the first aspect.

According to a fifth aspect, embodiments of the present disclosure provide a computer program product, including a computer program, wherein the computer program, when executed by a processor, implements the method for content rendering according to the first aspect and various possible designs of the first aspect.

### BRIEF DESCRIPTION OF THE DRAWINGS

Brief introduction of the drawings required in the following description of the embodiments or the prior art are to be introduced simply below to more clearly explain the technical solutions according to the embodiments of the present disclosure or in the related art. It is obvious that the following drawings only illustrate some embodiments of the present disclosure and those skilled in the art also may obtain other drawings on the basis those illustrated ones without any exercises of inventive work.

FIG. 1 illustrates a schematic flowchart of the method for content rendering provided by the embodiments of the present disclosure;

FIG. 2 illustrates a schematic diagram of the screen space after the partition based on the gaze point provided by the embodiments of the present disclosure;

FIG. 3 illustrates a schematic flowchart of the method for content rendering provided by a further embodiment;

FIG. 4 illustrates a schematic diagram of an application scenario provided by embodiments of the present disclosure;

FIG. 5 illustrates a schematic flowchart of the method for content rendering provided by a further embodiment;

FIG. 6 illustrates a schematic diagram of the application scenario provided by the embodiments of the present disclosure;

FIG. 7 illustrates a structural diagram of the apparatus for content rendering provided by embodiments of the present disclosure;

FIG. 8 illustrates a structural diagram of an electronic device provided by embodiments of the present disclosure.

### DETAILED DESCRIPTION OF EMBODIMENTS

For a clearer picture of the objectives, technical solutions and advantages of the embodiments of the present disclosure, the technical solutions in the embodiments of the present disclosure are to be described clearly and completely with reference to the drawings in the embodiments of the present disclosure. It is obvious that the described embodiments are only part of the embodiments of the present disclosure, rather than all of them. All other embodiments obtained by those skilled in the art based on the illustrated embodiments of the present disclosure without any exercises of inventive work fall within the protection scope of the present disclosure.

It is to be appreciated that prior to the use of the technical solutions disclosed by various embodiments of the present disclosure, type, usage scope and application scenario of personal information involved in the present disclosure are made known to users through suitable ways according to the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, according to the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws

To address the technical problems of current low rendering efficiency of the 3D scenes and the resulting high performance pressure on the rendering device, the present disclosure provides a method and apparatus for content rendering, a device, a computer-readable storage medium and a product.

It is to be explained that the method and apparatus for content rendering, the device, the computer-readable storage medium and the product provided by the present disclosure may be applied to content rendering scenes in any virtual reality contexts.

Recently, a series of 3D model representations (neural representations), led by Neural Radiance Field (NeRF for short), have been extensively recognized and used due to their significant advantages in realistic sense of the rendering and restoration degree of complex geometric structures. However, such 3D representations are rendered through an approximate ray tracing method. With high computation complexity, it is difficult to render in real time on the current mobile devices and it is more difficult on an all-in-one VR equipment since it is required to render high definition images simultaneously for the left eye and the right eye. 3DGS is a new technique for reconstructing and rendering high-fidelity scenes. Compared with NeRF methods, 3DGS utilizes rasterized lines during the rendering process, which highly improves the rendering efficiency and provides foundation for the real-time and high-fidelity rendering of the 3D scenes on the all-in-one VR equipment.

Although the 3DGS is improved in the rendering efficiency with respect to NeRF, the rendering speed is positively correlated with the number of Gaussian points of the 3DGS. In case of rendering scene-level data on mobile devices, the mobile devices still face performance pressure. Rendering of the gaze point is a common accelerating means on the VR equipment. The rendering performance is boosted by lowering the rendering resolution outside the gaze point area. However, since the 3DGS has spiking and dilation issues under different resolutions, it could not be straightforwardly combined with multi-resolution rendering the gaze point.

In finding a solution to the above technical problems, the inventor has discovered through study that in order to address spiking and dilation issues caused by combination of the 3DGS and the multi-resolution rendering of the gaze point, attenuation coefficients of the Gaussian spheres in the target area may be determined based on a projection matrix of a Gaussian sphere in a binocular camera coordinate system corresponding to the virtual reality equipment, a rendering resolution corresponding to a target area and a rendering resolution corresponding to the gaze area. Further, rendering parameters of pixel points can be determined based on the attenuation parameters and the color information corresponding to the Gaussian sphere; and the rendering operation is performed on the pixel points based on the rendering points.

Furthermore, the 3DGS starts a blend mode while rendering. It is required to render each Gaussian sphere from front to back to accumulate opacity, thereby obtaining the final color of each pixel. However, as each Gaussian sphere covers different areas and varies in its own opacity intensity, some pixels may be accumulated to be nearly completely opaque early at some depths; in such case, there is no need for following pixels to enter a pixel coloring phase. Accordingly, the Gaussian spheres to be rendered are classified into N groups from front to back, and each group is subject to normal rasterization and coloring procedure. Meanwhile, Splat pass is started and AlphaToDepth pass is inserted every two splat passes. The accumulated opacity of the current pixel is directly read from GMem (on-chip GPU memory) using surpassLoad. If the accumulated opacity is already lower than a threshold, the pixel is written into a depth buffer, wherein the threshold may be set to 0.01 by default; as the threshold increases, greater speedup ratio is provided, with degraded rendering quality. The subsequent Splat pass, when rendering to cover the pixel at the same position, may leave the coloring process early through the depth test.

Alternatively, due to binocular imaging characteristics of human eyes, disparity of distant objects is relatively small. Accordingly, the rendering results of the center eye may be projected to the left eye and the right eye separately to obtain an approximately accurate image, thereby reducing the rendering pressure on distant views. Based on AlphaToDepth pass, the content close to the camera may be rendered respectively for the left eye and the right eye; the contents distant from the camera may be rendered only for the left eye or the right eye as the parallax of distant objects when being viewed by human eyes is small; according to the rendering result of the left eye or the right eye and the depth graph, the rendering result is translated to the right eye or the left eye.

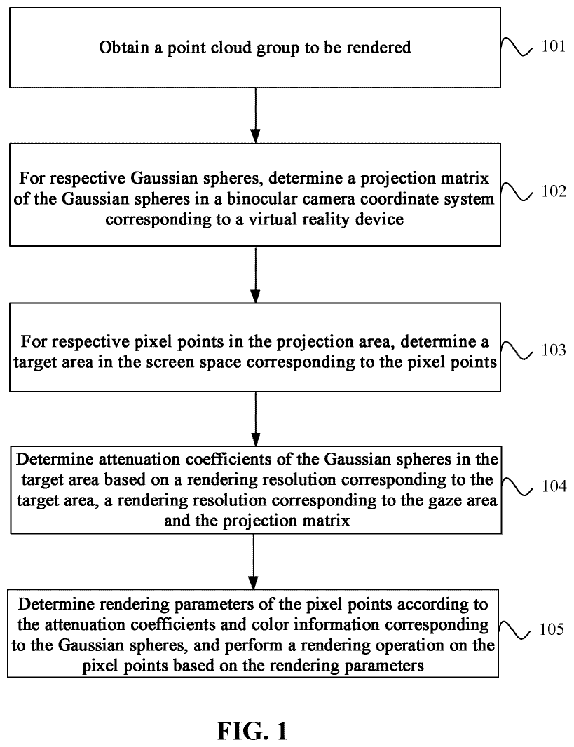

FIG. 1 illustrates a schematic flowchart of the method for content rendering provided by the embodiments of the present disclosure. As shown in FIG. 1, the method includes:
Step 101: a point cloud group to be rendered is obtained, the point cloud group including a plurality of Gaussian spheres characterizing a three-dimensional Gaussian distribution.

The executive body of the embodiment is an apparatus for content rendering, which may be coupled to the virtual reality equipment.

In this implementation, to perform the operation of rendering the contents of the 3D scenes, a point cloud group to be rendered is first obtained, wherein the point cloud group may include a plurality of point clouds characterizing Gaussian spheres in 3D Gaussian distribution. The point cloud group also may include a depth value corresponding to each Gaussian sphere.

Wherein the point cloud group may be created by any methods, which is not restricted in the present disclosure.
Step 102: for respective Gaussian spheres, a projection matrix of the Gaussian spheres in a binocular camera coordinate system corresponding to a virtual reality device is determined, the projection matrix being used for characterizing a projection area of the Gaussian spheres on a screen space corresponding to the virtual reality device.

In this implementation, in order to perform a rendering operation on areas covered by Gaussian spheres, it is required to determine a projection area of the Gaussian sphere on a corresponding screen space of the virtual reality device.

Optionally, for respective Gaussian spheres, a projection matrix of the Gaussian spheres in a binocular camera coordinate system corresponding to a virtual reality device is determined, i.e., covariance matrix, the projection matrix being used for characterizing a projection area of the Gaussian sphere on a screen space corresponding to the virtual reality device wherein this projection matrix may be calculated by any calculation methods of projection matrix, which is not restricted in the present disclosure.
Step 103: for respective pixel points in the projection area, a target area in the screen space corresponding to the pixel points is determined, wherein the screen space includes a plurality of areas partitioned based on a target gaze point and the areas include a gaze area and at least one edge area, the edge area having a rendering resolution less than the gaze area.

In this implementation, to lower the rendering pressure on the virtual reality equipment, the 3DGS may be combined with the multi-resolution rendering of the gaze point.

Alternatively, after the partition based on the gaze point, the screen control may be divided into a gaze area and at least one edge area, where the rendering resolution of the edge area is less than that of the gaze area.

Furthermore, the 3DGS, after being combined with the multi-resolution rendering of the gaze point, may face spiking and dilation issues in different resolutions. Therefore, to enhance the rendering quality of the 3D scenes, for respective pixel points corresponding to the Gaussian spheres in the projection area, a target area in the screen space corresponding to the pixel points may be determined; subsequently, an anti-aliasing operation can be performed based on the rendering resolution of the target area, the rendering resolution of the gaze area and the projection matrix.
Step 104: attenuation coefficients of the Gaussian spheres in the target area is determined based on a rendering resolution corresponding to the target area, a rendering resolution corresponding to the gaze area and the projection matrix.

In this implementation, after the rendering resolution corresponding to the target area, the rendering resolution corresponding to the gaze area and the projection matrix are respectively determined, the attenuation coefficients of the Gaussian spheres in the target area may be determined based on the rendering resolution corresponding to the target area, the rendering resolution corresponding to the gaze area and the projection matrix.

Wherein the attenuation coefficients may be calculated through formula 1.

$${\sum }_{mip}^{′} = ( {\sum }_{ori}^{′} - 0.1 * I ) * \frac{1}{{N}^{2}} + 0.1 * I \qquad ( 1 )$$

Where

$${\sum }_{ori}^{′}$$

is the projection matrix, I refers to unit matrix, N indicates a multiple relation between the rendering resolution corresponding to the target area and the rendering resolution corresponding to the gaze area.
Step 105: rendering parameters of the pixel points is determined according to the attenuation coefficients and color information corresponding to the Gaussian spheres, and a rendering operation on the pixel points is performed based on the rendering parameters.

In this implementation, after the attenuation coefficients are determined, the rendering parameters of respective pixel points in the areas covered by the Gaussian spheres may be determined based on the attenuation parameters, wherein the rendering parameters include opacity (alpha channel value) and rendering color (spherical harmonic coefficient). Subsequently, the pixel points may be rendered accurately based on the rendering parameters.

As an implementable approach, different multi-resolution levels may also be set for the Gaussian spheres via variable shading rate (VRS for short), in addition to the multi-resolution mode of the gaze point.

Wherein the setting may be made according to the depth, volume and opacity intensity of the current Gaussian sphere. For example, as the depth increases/volume grows/opacity intensity lowers, the resolution level decreases.

By way of a practical example, the shading rate in general may be set to ½, ¼, ⅛ and 1/16 (corresponding to 1/N in the above formula); the shading rate may be determined based on three attributes of the Gaussian sphere.

For example, different levels of shading rates may be set depending on a distance (depth value) between the Gaussian sphere and the camera.

Or different levels of shading rates may be set according to the longest axis (pixel length) decomposed from the projection matrix of the current Gaussian sphere.

Alternatively, different shading rates may be set based on the opacity of the current Gaussian sphere.

The method for content rendering provided by this embodiment combines with the gaze point rendering while the 3D scenes are rendered by the 3DGS, to perform the rendering acceleration operation, so as to effectively enhance the rendering efficiency of the 3D scenes on a mobile device like VR equipment etc. Besides, by determining attenuation coefficients of the Gaussian spheres in the target area based on a rendering resolution corresponding to the target area, a rendering resolution corresponding to the gaze area and the projection matrix and determining rendering parameters associated with the pixel points according to the attenuation coefficients, the spiking and dilation issues caused by combination of the 3DGS and the multi-resolution rendering of the gaze point can be effectively solved, so as to enhance the rendering efficiency while the rendering quality is guaranteed.

Optionally, based on any of the above embodiments, prior to step 103, the method further includes:
determining a current target gaze point;
drawing, in the screen space, a preset number of concentric circles with the target gaze point as center;
determining a concentric circle at the center position as the gaze area and determining at least one concentric circle outside the gaze area as at least one edge area;
setting rendering resolutions for the gaze area and the at least one edge area based on preset partition parameters.

In this embodiment, to lower the rendering pressure on the virtual reality equipment, the 3DGS may be combined with the multi-resolution rendering of the gaze point. After the partition based on the gaze point, the screen control may be divided into a gaze area and at least one edge area, where the rendering resolution of the edge area is less than that of the gaze area.

Alternatively, a current target gaze point may be determined and a preset number of concentric circles are drawn in the screen space with the target gaze point as center, wherein the concentric circles may be drawn based on preset drawing parameters, to flexibly control the coverage area of each area.

Furthermore, a concentric circle at the center position may be determined as the gaze area and at least one concentric circle outside the gaze area is determined as at least one edge area. Rendering resolutions for the gaze area and the at least one edge area are set based on preset partition parameters, wherein the partition parameters may include preset rendering resolutions corresponding to respective partitions. It is to be noted that the gaze area has a rendering resolution greater than that of the edge area, so as to improve rendering efficiency while the rendering effects are guaranteed.

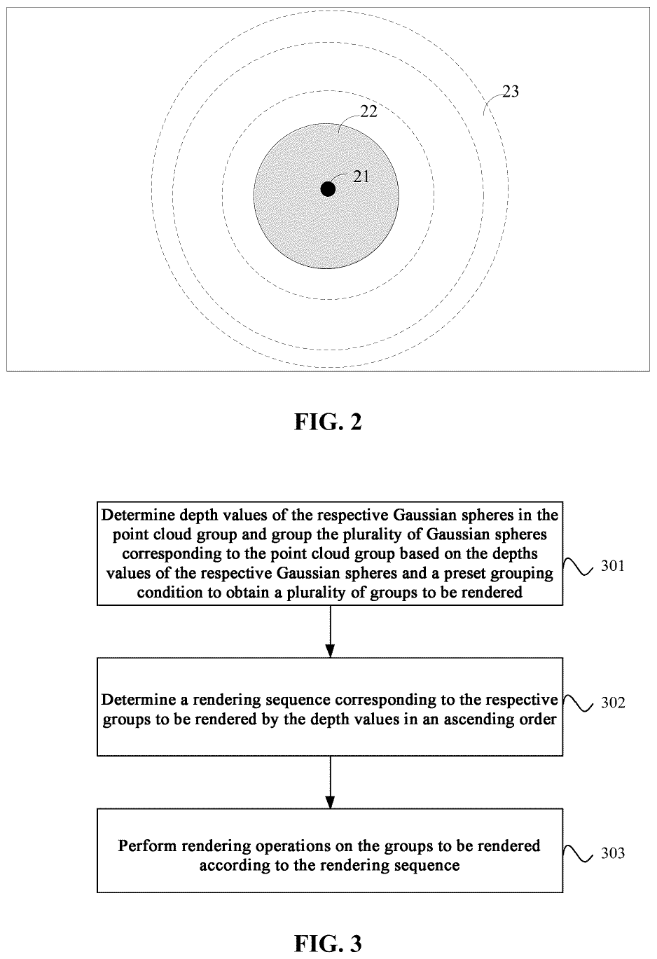

FIG. 2 illustrates a schematic diagram of the screen space after the partition based on the gaze point provided by the embodiments of the present disclosure. As shown in FIG. 2, the target gaze point 21 may be a center area of the screen space. A preset number of concentric circles are drawn in the screen space with the target gaze point 21 as the center. Concentric circles 22 at the center position may be determined as the gaze area and at least one concentric circle 23 outside the gaze area is determined as at least one edge area, wherein the edge area has a rendering resolution less than that of the gaze area.

The method for content rendering provided by this embodiment partitions the screen space based on the target gaze point and sets rendering resolutions for the gaze area and the at least one edge area based on the preset partition parameters, to effectively decrease the rendering resolution outside the gaze point area and further enhance the rendering speed of the 3D scenes.

Furthermore, based on any of the above embodiments, the determining a current target gaze point includes:
identifying an eye movement feature of a user through a preset eye movement tracking technique;
determining a current gaze point of the user based on the eye movement feature and determining the current gaze point of the user as the target gaze point;
or,
determining a center area of the screen space and determining the center area as the target gaze point.

In this embodiment, the target gaze point may be the center position of the screen space, or may be determined by the tracking the eye movement feature of users. The present disclosure is not restricted in this regard. The users may switch the methods for determining the target gaze point depending on the actual needs.

Alternatively, the eye movement feature of a user may be identified through a preset eye movement tracking technique. The current gaze point of the user is determined based on the eye movement feature and the current gaze point of the user is determined as the target gaze point, wherein the eye movement feature may be tracked using any eye movement tracking methods. The present disclosure is not restricted in this regard.

Or a center area of the screen space is determined and the center area is determined as the target gaze point.

The method for content rendering provided by this embodiment determines the target gaze point based on the center area of the screen space or the eye movement feature, so as to flexibly determine the target gaze point and further more accurately perform screen partition operation based on the target gaze point.

Furthermore, based on any of the above embodiments, the rendering parameters include opacity and rendering color. Step 105 includes:
determining opacity corresponding to the pixel points according to the attenuation parameters and a preset opacity algorithm;
obtaining rendering colors corresponding to the pixel points by multiplying color information corresponding to the Gaussian spheres by the opacity;
performing a rendering operation on the pixel points based on the opacity and the rendering color.

In this embodiment, after the attenuation coefficients are determined, opacity corresponding to the pixel points may be calculated according to the attenuation parameters and a preset opacity algorithm, wherein the opacity algorithm may be the one shown in formula 2:

$$alpha = \frac{opacity}{\sqrt{\frac{det ( {\sum }_{mip}^{′} - 0.1 * I )}{det ( {\sum }_{mip}^{′} )}}} * {exp}^{\frac{‖ pix - {pix}_{center} ‖}{{N}^{2}}} \qquad ( 2 )$$

Wherein

$${\sum }_{mip}^{′}$$

indicates attenuation coefficient, opacity refers to an opacity of the current Gaussian sphere, pix represents the coordinates of the current pixel point, pix_{center} is the coordinates of the center pixel point of the current Gaussian sphere; and I is a unit matrix.

Subsequent to the determination of the opacity corresponding to the pixel points, rendering colors corresponding to the pixel points may be obtained by multiplying color information corresponding to the Gaussian spheres by the opacity. A rendering operation is performed on the pixel points based on the opacity and the rendering color.

The method for content rendering provided by this embodiment, after the determination of the attenuation coefficients, determines the opacity based on the attenuation coefficients and determines rendering colors corresponding to the pixel points according to the attenuation parameters and the color information corresponding to the Gaussian sphere, so as to accurately determine the rendering parameters corresponding to respective pixel points after the partition based on the target gaze point and further effectively address the spiking and dilation issues caused by combination of the 3DGS and the multi-resolution rendering of the gaze point, thereby enhancing the rendering precision of the 3D scenes.

FIG. 3 illustrates a schematic flowchart of the method for content rendering provided by a further embodiment. Based on any of the above embodiments, the method as shown in FIG. 3 further includes:
Step 301: depth values of respective Gaussian spheres in the point cloud group are determined and the plurality of Gaussian spheres corresponding to the point cloud group are grouped based on the depths values of the respective Gaussian spheres and a preset grouping condition, to obtain a plurality of groups to be rendered;
Step 302: a rendering sequence corresponding to respective groups to be rendered is determined by the depth values in an ascending order;
Step 303: rendering operations on the groups to be rendered are performed according to the rendering sequence.

In this embodiment, there is a plurality of subpass during the 3DGS rendering and the opacity is accumulated for each Gaussian sphere during the rendering process, to obtain the final color of each pixel, wherein some pixels may be accumulated to the effect of a near complete opacity early; in such case, there is no need to perform the rendering operation on the following pixels, which enhances the rendering speed of the 3D scenes.

Accordingly, the areas covered by the Gaussian spheres may be rendered sequentially according to their distance to the camera from the nearest to the farthest, to determine the accumulated opacity corresponding to respective pixel points.

The point cloud group includes depths values corresponding to respective Gaussian spheres. Therefore, a plurality of Gaussian spheres corresponding to the point cloud group may be grouped based on depths values of respective Gaussian spheres and a preset grouping condition, to obtain a plurality of groups to be rendered. The rendering sequence corresponding to each group to be rendered is determined according to depth values in an ascending order. The rendering operations are performed on the groups to be rendered according to the rendering sequence.

For example, the Gaussian sphere closest to the camera is rendered first. After the rendering is completed, if it is determined that the area covered by this Gaussian sphere has pixel points which are nearly completely opaque, the following pixel points would be blocked. Thus, when the areas covered by other Gaussian spheres are rendered in the future, there is no need to perform a rendering operation on the following pixels.

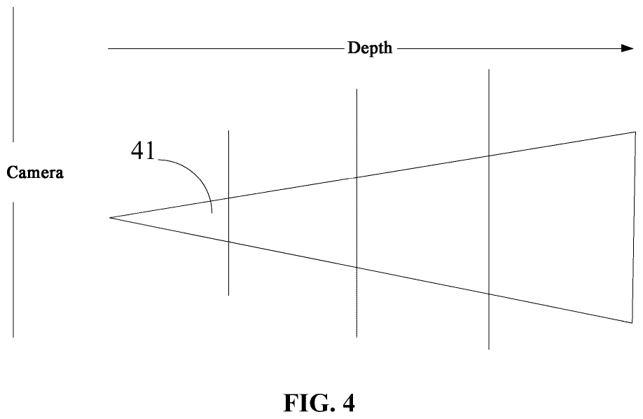

FIG. 4 illustrates a schematic diagram of an application scenario provided by embodiments of the present disclosure. As shown in FIG. 4, a plurality of Gaussian spheres corresponding to the point cloud group may be grouped based on depths values corresponding to respective Gaussian spheres and a preset grouping condition, to obtain a plurality of groups to be rendered 41. Further, the rendering sequence corresponding to each group to be rendered 41 is determined according to depth values in an ascending order.

The method for content rendering provided by this embodiment groups the Gaussian spheres according to the depth value and determines the rendering sequence of each group to be rendered based on the depth values, so as to accurately perform the rendering operation according to a distance to the camera from the nearest to the farthest.

Moreover, based on any of the above embodiments, the step 303 includes:
determining a current group to be rendered, performing a rendering operation on the current group to be rendered via a preset sub-channel and storing a rendering result to a preset storage path, wherein the rendering result at least includes opacity of pixel points corresponding to respective Gaussian spheres in the group to be rendered and the storage path includes all rendering results corresponding to already rendered groups to be rendered;
performing an opacity test operation based on all rendering results in the storage path to obtain a test result, wherein the test result includes an accumulated opacity of respective pixel points corresponding to already rendered groups to be rendered;
obtaining a next group to be rendered according to the rendering sequence; and determining, for each pixel point associated with Gaussian spheres in the next group to be rendered, whether an accumulated opacity of rendered pixel points at positions associated with the pixel point reaches a preset threshold based on the test result;
if the accumulated opacity associated with the pixel point reaches the preset threshold, stopping performing the rendering operations on the pixel point;
if the accumulated depth value associated with the pixel point fails to reach a preset threshold, or the pixel point is not associated with the accumulated opacity, performing the rendering operations on the pixel point based on the rendering parameters.

In this embodiment, the 3DGS starts a blend mode while rendering. It is required to render each Gaussian sphere from front to back to accumulate opacity, thereby obtaining the final color of each pixel. However, as each Gaussian sphere covers different areas and varies in its own opacity intensity, some pixels may be accumulated to be nearly completely opaque early at some depths; in such case, there is no need for following pixels to enter a pixel coloring phase.

Accordingly, while the rendering operation is being performed sequentially on the groups to be rendered according to their distance to the camera from the nearest to the farthest, the rendering result of each group to be rendered which has been rendered is stored, wherein the rendering result at least includes opacity of pixel points corresponding to respective Gaussian spheres in the group to be rendered. As such, an opacity test operation may be performed between two adjacent groups to be rendered, to determine whether the pixel point corresponding to the current group to be rendered has reached an opacity threshold. The following rendering operations are performed based on the test result.

Alternatively, a current group to be rendered is determined, a rendering operation is performed on the current group to be rendered via a preset sub-channel and a rendering result is stored to a preset storage path, wherein the rendering result at least includes opacity of pixel points corresponding to respective Gaussian spheres in the group to be rendered and the storage path includes all rendering results corresponding to already rendered groups to be rendered.

An opacity test operation is performed based on all rendering results in the storage path to obtain a test result, wherein the test result includes an accumulated opacity of respective pixel points corresponding to already rendered groups to be rendered. For example, the opacity of each pixel point in multiple subpass procedures may be accumulated to determine the accumulated opacity of each pixel point.

Furthermore, a next group to be rendered may be obtained according to the rendering sequence; and for each pixel point associated with Gaussian spheres in the next group to be rendered, it is determined whether an accumulated opacity of rendered pixel points at positions associated with the pixel point reaches a preset threshold based on the test result, wherein the preset threshold may be 0.01, or the preset threshold may be set by users according to the actual needs. The present disclosure is not restricted in this regard. The size of the preset threshold is in proportion to the acceleration. However, the rendering quality may be degraded with a greater threshold. Thus, the users may configure the preset threshold in view of the actual requirements.

If the accumulated opacity of the rendered pixel points reaches the preset threshold, it indicates that the pixel points are nearly completely opaque and would block the following pixels; in such case, there is no need to subject the following pixels to the pixel coloring phase. The rendering operations on the pixel points is terminated. On the contrary, if the accumulated depth value associated with the pixel point fails to reach the preset threshold, or the pixel point is not associated with the accumulated opacity, the rendering operations are performed on the pixel point based on the rendering parameters.

The method for content rendering provided by this embodiment sequentially performs the rendering operation on the groups to be rendered according to their distance to the camera from the nearest to the farthest and stores the rendering result, so as to perform an opacity test based on the stored rendering result. Further, in case of rendering distant Gaussian spheres, the method can identify pixel points with an opacity reaching the preset threshold, so as to exit the coloring process of these pixel points in advance, decrease the number of pixel points to be rendered and effectively enhance the rendering efficiency.

Alternatively, based on any of the above embodiments, the binocular camera includes a left-eye camera and a right-eye camera.

The step 102 includes:
determining a first projection matrix of the Gaussian spheres in a left-eye camera coordinate system and determining a second projection matrix of the Gaussian spheres in a right-eye camera coordinate system.

In this embodiment, the virtual reality equipment is provided with a binocular camera, which may respectively include a left-eye camera and a right-eye camera. The left-eye camera and the right-eye camera have the same depth, but vary in horizontal parameters. Therefore, the corresponding projection matrixes are also different.

Accordingly, a first projection matrix of the Gaussian spheres in a left-eye camera coordinate system and a second projection matrix of the Gaussian spheres in a right-eye camera coordinate system are determined. The projection matrix associated with the binocular camera may be calculated by any methods for calculating the projection matrix. The present disclosure is not restricted in this regard.

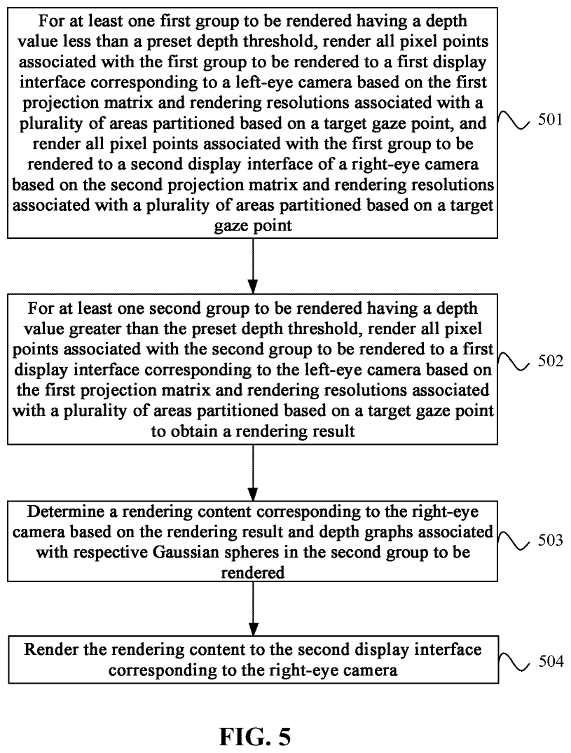

FIG. 5 illustrates a schematic flowchart of the method for content rendering provided by a further embodiment. Based on any of the above embodiments, as shown in FIG. 5, after the determining a first projection matrix of the Gaussian spheres in a left-eye camera coordinate system and determining a second projection matrix of the Gaussian spheres in a right-eye camera coordinate system, the method further includes:
Step 501: for at least one first group to be rendered having a depth value less than a preset depth threshold, all pixel points associated with the first group to be rendered are rendered to a first display interface corresponding to a left-eye camera based on the first projection matrix and rendering resolutions associated with a plurality of areas partitioned based on a target gaze point, and all pixel points associated with the first group to be rendered are rendered to a second display interface of a right-eye camera based on the second projection matrix and rendering resolutions associated with a plurality of areas partitioned based on a target gaze point;
Step 502: for at least one second group to be rendered having a depth value greater than a preset depth threshold, all pixel points associated with the second group to be rendered are rendered to a first display interface corresponding to a left-eye camera based on the first projection matrix and rendering resolutions associated with a plurality of areas partitioned based on a target gaze point, to obtain a rendering result;
Step 503: a rendering content corresponding to a right-eye camera is determined based on the rendering result and depth graphs associated with respective Gaussian spheres in the second group to be rendered;
Step 504: the rendering content is rendered to a second display interface corresponding to a right-eye camera.

In this embodiment, due to binocular imaging characteristics of human eyes, the disparity is large in case of viewing near objects and is relatively small when viewing distant objects. Therefore, for the near 3D scenes, the rendering operation is performed respectively on the left eye and the right eye. However, with respect to the distant 3D scenes, the rendering may be performed on one side and the rendering result based on one side and the depth information may be translated to the other side, to enhance the rendering speed.

Alternatively, the point cloud group includes the depth information of each Gaussian sphere. Therefore, for at least one first group to be rendered having a depth value less than a preset depth threshold, i.e., the 3D scene close to the camera, the rendering operation may be performed on the left eye and the right eye respectively. The rendering parameters of all pixel points associated with the first group to be rendered may be determined based on the first projection matrix and rendering resolutions associated with a plurality of areas partitioned based on a target gaze point, and all pixel points are rendered to a first display interface corresponding to a left-eye camera based on the rendering parameters. The rendering parameters of all pixel points associated with the first group to be rendered may be determined based on the second projection matrix and rendering resolutions associated with a plurality of areas partitioned based on a target gaze point, and all pixel points are rendered to a second display interface corresponding to a right-eye camera based on the rendering parameters.

For at least one second group to be rendered having a depth value greater than a preset depth threshold, i.e., the 3D scene distant from the camera, the rendering operation may be performed only on one side and the rendering result is translated to the other side based on the rendering result of one side and the depth information. Accordingly, the rendering parameters of all pixel points associated with the second group to be rendered may be determined based on the first projection matrix and rendering resolutions associated with a plurality of areas partitioned based on a target gaze point, and all pixel points associated with the second group to be rendered are rendered to a first display interface corresponding to a left-eye camera based on the rendering parameters to obtain a rendering result. To make the display effect in the second display interface closer to the actual 3D scene, rendering content corresponding to a right-eye camera also may be determined based on the rendering result and depth graphs associated with respective Gaussian spheres in the second group to be rendered. The rendering content is rendered to a second display interface corresponding to a right-eye camera.

The method for content rendering provided by this embodiment may perform the rendering operation on the left eye and right eye respectively for at least one first group to be rendered having a depth value less than a preset depth threshold. For at least one second group to be rendered having a depth value greater than a preset depth threshold, only the left eye or the right eye is rendered as the disparity is small when the distant object is viewed by human eyes. Based on the rendering result of the left eye or the right eye and the depth graph, the rendering result is translated to the right eye or the left eye, so as to further improve the rendering speed of the 3D scenes.

As an implementable approach, Multi-Plane Image (MPI for short) also may be used to perform a re-projection operation on the rendering result of one side.

Wherein the single-sided rendering result of the distant view may be divided into N groups along a depth direction. N groups of rendering results of the distant view having different depths are horizontally translated to the other side, which are rendered and combined into one rendering result according to a preset MPI formula. The rendering results of the distant view for the other side are mixed with the rendering results of foreground.

Wherein the horizontal translation amount may be calculated by the formula 3:

$${D}_{p} ( d ) = \frac{{D}_{c} F}{d} \qquad ( 3 )$$

Wherein D_{c} indicates a distance between the left eye and the right eye of the binocular camera, F is the focal length and d refers to the rendering depth.

Furthermore, after the horizontal translation, the rendering may be combined into one rendering result according to the MPI formula, wherein the MPI formula may be indicated as formula 4:

$$C = {\sum }_{i = 1}^{n} {α}_{i} {c}_{i} {\prod }_{j - i + 1}^{n} ( 1 - {α}_{j} ) \qquad ( 4 )$$

Wherein n indicates the arrangement according to the plane distance from farthest to nearest, cᵢ refers to a pixel color of an intersection of rays towards optic center on the plane I, and aᵢ represents the corresponding opacity.

Moreover, based on any of the above embodiments, the step 503 includes:
constructing a tessellated grid aligned with the second display interface;
performing a depth shift operation on the tessellated grid based on depth graphs associated with the respective Gaussian spheres to obtain a shifted grid;
rendering the rendering result as a texture image to the shifted grid to obtain the rendering content.

In this embodiment, in order to translate the rendering result to the second display interface, a tessellated grid aligned with the second display interface may be displayed. A depth shift operation is performed on the tessellated grid based on depth graphs associated with the respective Gaussian spheres to obtain a shifted grid. The rendering result as a texture image is further rendered to the shifted grid to obtain the rendering content.

After the rendering result of the first display interface is translated to the second display interface through depth shift, it is only required to perform the rendering of the 3D scene on the first display interface, to achieve the binocular rendering effects and effectively improve the rendering speed of the 3D scene.

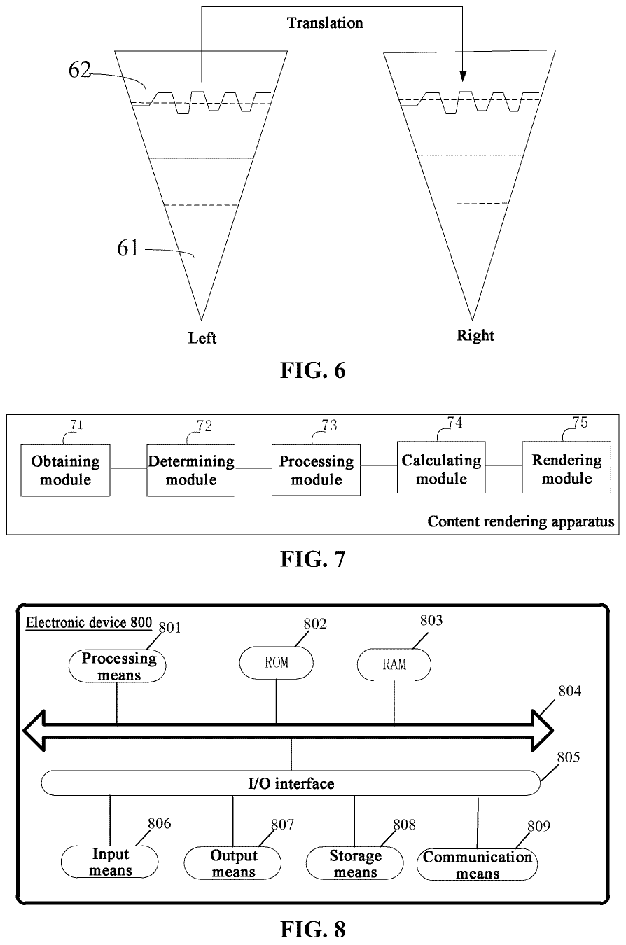

FIG. 6 illustrates a schematic diagram of the application scenario provided by the embodiments of the present disclosure. As shown in FIG. 6, the virtual reality equipment has a binocular camera and a binocular display screen, wherein the left-eye camera and the right-eye camera have the same depth and different projection matrixes. Due to binocular imaging characteristics of human eyes, disparity of distant objects is relative small. Therefore, with respect to the display content 61 close to the camera, the rendering operation may be performed respectively on the left eye and the right eye. For the display content 62 distant from the camera, the rendering is performed only on the left eye or the right eye since the disparity of the human eyes is small when viewing the distant objects. Based on the rendering result of the left eye or the right eye and the depth graph, the rendering result is translated to the right eye or the left eye.

The method for content rendering provided by this embodiment constructs a tessellated grid aligned with the second display interface and performs a depth shift operation on the tessellated grid based on depth graphs associated with the respective Gaussian spheres to obtain a shifted grid, so as to accurately translate the rendering result to the second display interface based on the shifted grid and the rendering result. The rendering precision of the 3D scene is therefore improved.

FIG. 7 illustrates a structural diagram of the apparatus for content rendering provided by embodiments of the present disclosure. As shown in FIG. 7, the apparatus includes: an obtaining module 71 configured to obtain a point cloud group to be rendered, the point cloud group including a plurality of Gaussian spheres characterizing a three-dimensional Gaussian distribution; a determining module 72 configured to determine, for respective Gaussian spheres, a projection matrix of the Gaussian spheres in a binocular camera coordinate system corresponding to a virtual reality device, the projection matrix being used for characterizing a projection area of the Gaussian spheres on a screen space corresponding to the virtual reality device; a processing module 73 configured to determine, for respective pixel points in the projection area, a target area in the screen space corresponding to the pixel points, wherein the screen space includes a plurality of areas partitioned based on a target gaze point and the areas include a gaze area and at least one edge area, the edge area having a rendering resolution less than the gaze area; a calculating module 74 configured to determine attenuation coefficients of the Gaussian spheres in the target area based on a rendering resolution corresponding to the target area, a rendering resolution corresponding to the gaze area and the projection matrix; and a rendering module 75 configured to determine rendering parameters of the pixel points according to the attenuation coefficients and color information corresponding to the Gaussian spheres, and perform a rendering operation on the pixel points based on the rendering parameters.

Moreover, based on any of the above embodiments, the apparatus further includes a determining module configured to determine a current target gaze point; a drawing module configured to draw, in the screen space, a preset number of concentric circles with the target gaze point as center; a processing module configured to determine a concentric circle at the center position as the gaze area and determine at least one concentric circle outside the gaze area as at least one edge area; and a setting module configured to set rendering resolutions for the gaze area and the at least one edge area based on preset partition parameters.

Moreover, based on any of the above embodiments, the determining module is configured to: identify an eye movement feature of a user through a preset eye movement tracking technique; determine a current gaze point of the user based on the eye movement feature and determine the current gaze point of the user as the target gaze point; or determine a center area of the screen space and determine the center area as the target gaze point.

Based on any of the above embodiments, the rendering parameters include opacity and rendering color. The rendering module is configured to: determine opacity corresponding to the pixel points according to the attenuation parameters and a preset opacity algorithm; obtain rendering colors corresponding to the pixel points by multiplying color information corresponding to the Gaussian spheres by the opacity; perform a rendering operation on the pixel points based on the opacity and the rendering color.

Based on any of the above embodiments, the apparatus further includes: a determining module configured to determine depth values of respective Gaussian spheres in the point cloud group and group the plurality of Gaussian spheres corresponding to the point cloud group based on the depths values of the respective Gaussian spheres and a preset grouping condition, to obtain a plurality of groups to be rendered; a processing module configured to determine a rendering sequence corresponding to respective groups to be rendered by the depth values in an ascending order; and a rendering module configured to perform rendering operations on the groups to be rendered according to the rendering sequence.

Based on any of the above embodiments, the rendering module is configured to: determine a current group to be rendered, perform a rendering operation on the current group to be rendered via a preset sub-channel and store a rendering result to a preset storage path, wherein the rendering result at least includes opacity of pixel points corresponding to respective Gaussian spheres in the group to be rendered and the storage path includes all rendering results corresponding to already rendered groups to be rendered; perform an opacity test operation based on all rendering results in the storage path to obtain a test result, wherein the test result includes an accumulated opacity of respective pixel points corresponding to already rendered groups to be rendered; obtain a next group to be rendered according to the rendering sequence; and determine, for each pixel point associated with Gaussian spheres in the next group to be rendered, whether an accumulated opacity of rendered pixel points at positions associated with the pixel point reaches a preset threshold based on the test result; if the accumulated opacity associated with the pixel point reaches the preset threshold, stopping rendering operations on the pixel point; if the accumulated depth value associated with the pixel point fails to reach a preset threshold, or the pixel point is not associated with an accumulated opacity, performing the rendering operations on the pixel point based on the rendering parameters.

Based on any of the above embodiments, the binocular camera includes a left-eye camera and a right-eye camera. The determining module is configured to: determine a first projection matrix of the Gaussian spheres in a left-eye camera coordinate system and determine a second projection matrix of the Gaussian spheres in a right-eye camera coordinate system.

Based on any of the above embodiments, the apparatus further includes: a rendering module configured to: for at least one first group to be rendered having a depth value less than a preset depth threshold, render all pixel points associated with the first group to be rendered to a first display interface corresponding to a left-eye camera based on the first projection matrix and rendering resolutions associated with a plurality of areas partitioned based on a target gaze point, and render all pixel points associated with the first group to be rendered to a second display interface of a right-eye camera based on the second projection matrix and rendering resolutions associated with a plurality of areas partitioned based on a target gaze point. The rendering module is further configured to: for at least one second group to be rendered having a depth value greater than a preset depth threshold, render all pixel points associated with the second group to be rendered to a first display interface corresponding to a left-eye camera based on the first projection matrix and rendering resolutions associated with a plurality of areas partitioned based on a target gaze point, to obtain a rendering result. The determining module is configured to determine a rendering content corresponding to a right-eye camera based on the rendering result and depth graphs associated with respective Gaussian spheres in the second group to be rendered. The rendering module is further configured to render the rendering content to a second display interface corresponding to a right-eye camera.

Furthermore, based on any of the above embodiments, the determining module is configured to: construct a tessellated grid aligned with the second display interface; perform a depth shift operation on the tessellated grid based on depth graphs associated with the respective Gaussian spheres to obtain a shifted grid; and render the rendering result as a texture image to the shifted grid to obtain the rendering content.

The device provided by this embodiment may be used to execute the technical solution of the above method embodiments. The implementation principles and the technical effects are similar and will not be repeated here.

To implement the above embodiments, embodiments of the present disclosure also provide a computer-readable storage medium stored with computer-executable instructions therein, wherein the computer-executable instructions, when executed by a processor, implement the method for content rendering according to any of the above embodiments.

To implement the above embodiments, embodiments of the present disclosure also provide a computer program product including a computer program, wherein the computer program, when executed by a processor, implements the method for content rendering according to any of the above embodiments.

To implement the above embodiments, embodiments of the present disclosure also provide an electronic device, including: a processor and a memory;
wherein the memory is stored with computer-executable instructions;
the processor executes computer-executable instructions stored in the memory, such that the processor performs the method for content rendering according to any of the above embodiments.

FIG. 8 illustrates a structural diagram of an electronic device provided by embodiments of the present disclosure. The electronic device 800 may be a terminal device or a server, wherein the terminal device may include, but not limited to, mobile terminals, such as mobile phones, notebooks, digital broadcast receivers, PDA (Personal Digital Assistant), PAD (Portable Android Device), PMP (Portable Multimedia Player) and vehicle terminals (such as car navigation terminal) and fixed terminals, e.g., digital TVs and desktop computers etc. The electronic device shown in FIG. 8 is just an example and will not put any restrictions on the functions and application ranges of the embodiments of the present disclosure.

As shown in FIG. 8, the electronic device 800 may include a processing means (e.g., central processor, graphic processor and the like) 801, which can execute various suitable actions and processing based on the programs stored in the read-only memory (ROM) 802 or programs loaded in the random-access memory (RAM) 803 from a storage means 808. The RAM 803 can also store all kinds of programs and data required by the operations of the electronic device 800. Processing means 801, ROM 802 and RAM 803 are connected to each other via a bus 804. The input/output (I/O) interface 805 is also connected to the bus 804.

Usually, input means 806 (including touch screen, touchpad, keyboard, mouse, camera, microphone, accelerometer, gyroscope and like) and output means 807 (including liquid crystal display (LCD), speaker and vibrator etc.), storage means 808 (including tape and hard disk etc.) and communication means 809 may be connected to the I/O interface 805. The communication means 809 may allow the electronic device 800 to exchange data with other devices through wired or wireless communications. Although FIG. 8 illustrates the electronic device 800 having various means, it is to be understood that it is not a prerequisite to implement or provide all illustrated means. Alternatively, more or less means may be implemented or provided.

In particular, according to embodiments of the present disclosure, the process depicted above with reference to the flowchart may be implemented as computer software programs. For example, the embodiments of the present disclosure include a computer program product including a computer program carried on a non-transitory computer readable medium, wherein the computer program includes program codes for executing the method demonstrated by the flowchart. In these embodiments, the computer program may be loaded and installed from networks via the communication means 809, or installed from the storage means 808, or installed from the ROM 802. The computer program, when executed by the processing means 801, performs the above functions defined in the method according to the embodiments of the present disclosure.

It is to be explained the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

The above computer readable medium may be included in the aforementioned electronic device or stand-alone without fitting into the electronic device.

The above computer readable medium bears one or more programs. When the above one or more programs are executed by the electronic device, the electronic device is enabled to execute the method illustrated by the above embodiments.

Computer program instructions for executing operations of the present disclosure are written in one or more programming languages or combinations thereof. The above programming languages include object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit should not be considered as the restriction over the unit per se. For example, the first obtaining unit also may be described as “a unit for obtaining at least two Internet protocol addresses”.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

In a first aspect, according to one or more embodiments of the present disclosure, there is provided a method for content rendering, including:
obtaining a point cloud group to be rendered, the point cloud group including a plurality of Gaussian spheres characterizing a three-dimensional Gaussian distribution;
for respective Gaussian spheres, determining a projection matrix of the Gaussian spheres in a binocular camera coordinate system corresponding to a virtual reality device, the projection matrix being used for characterizing a projection area of the Gaussian spheres on a screen space corresponding to the virtual reality device;
for respective pixel points in the projection area, determining a target area in the screen space corresponding to the pixel points, wherein the screen space includes a plurality of areas partitioned based on a target gaze point and the areas include a gaze area and at least one edge area, the edge area having a rendering resolution less than the gaze area;
determining attenuation coefficients of the Gaussian spheres in the target area based on a rendering resolution corresponding to the target area, a rendering resolution corresponding to the gaze area and the projection matrix;
determining rendering parameters of the pixel points according to the attenuation coefficients and color information corresponding to the Gaussian spheres, and performing a rendering operation on the pixel points based on the rendering parameters.

According to one or more embodiments of the present disclosure, before the determining, for respective pixel points in the projection area, a target area in the screen space corresponding to the pixel points, the method further includes:
determining a current target gaze point;
drawing, in the screen space, a preset number of concentric circles with the target gaze point as center;
determining a concentric circle at the center position as the gaze area and determining at least one concentric circle outside the gaze area as at least one edge area;
setting rendering resolutions for the gaze area and the at least one edge area based on preset partition parameters.

According to one or more embodiments of the present disclosure, the determining a current target gaze point includes:
identifying an eye movement feature of a user through a preset eye movement tracking technique;
determining a current gaze point of the user based on the eye movement feature and determining the current gaze point of the user as the target gaze point;
or,
determining a center area of the screen space and determining the center area as the target gaze point.

According to one or more embodiments of the present disclosure, the rendering parameters include opacity and rendering color;
the determining rendering parameters of the pixel points according to the attenuation coefficients and color information corresponding to the Gaussian spheres, and performing a rendering operation on the pixel points based on the rendering parameters include:
determining opacity corresponding to the pixel points according to the attenuation parameters and a preset opacity algorithm;
obtaining rendering colors corresponding to the pixel points by multiplying color information corresponding to the Gaussian spheres by the opacity;
performing a rendering operation on the pixel points based on the opacity and the rendering color.

According to one or more embodiments of the present disclosure, the method further includes:
determining depth values of respective Gaussian spheres in the point cloud group and grouping the plurality of Gaussian spheres corresponding to the point cloud group based on the depths values of the respective Gaussian spheres and a preset grouping condition, to obtain a plurality of groups to be rendered;
determining a rendering sequence corresponding to respective groups to be rendered by the depth values in an ascending order;
performing rendering operations on the groups to be rendered according to the rendering sequence.

According to one or more embodiments of the present disclosure, the performing rendering operations on the groups to be rendered according to the rendering sequence includes:
determining a current group to be rendered, performing a rendering operation on the current group to be rendered via a preset sub-channel and storing a rendering result to a preset storage path, wherein the rendering result at least includes opacity of pixel points corresponding to respective Gaussian spheres in the group to be rendered and the storage path includes all rendering results corresponding to already rendered groups to be rendered;
performing an opacity test operation based on all rendering results in the storage path to obtain a test result, wherein the test result includes an accumulated opacity of respective pixel points corresponding to already rendered groups to be rendered;
obtaining a next group to be rendered according to the rendering sequence; and determining, for each pixel point associated with Gaussian spheres in the next group to be rendered, whether an accumulated opacity of rendered pixel points at positions associated with the pixel point reaches a preset threshold based on the test result;
if the accumulated opacity associated with the pixel point reaches a preset threshold, stopping performing the rendering operations on the pixel point;
if the accumulated depth value associated with the pixel point fails to reach a preset threshold, or the pixel point is not associated with an accumulated opacity, performing the rendering operations on the pixel point based on the rendering parameters.

According to one or more embodiments of the present disclosure, the binocular camera includes a left-eye camera and a right-eye camera;
the determining a projection matrix of the Gaussian spheres in a binocular camera coordinate system corresponding to a virtual reality device includes:
determining a first projection matrix of the Gaussian spheres in a left-eye camera coordinate system and determining a second projection matrix of the Gaussian spheres in a right-eye camera coordinate system.

According to one or more embodiments of the present disclosure, after the determining a first projection matrix of the Gaussian spheres in a left-eye camera coordinate system and determining a second projection matrix of the Gaussian spheres in a right-eye camera coordinate system, the method further includes:
for at least one first group to be rendered having a depth value less than a preset depth threshold, rendering all pixel points associated with the first group to be rendered to a first display interface corresponding to a left-eye camera based on the first projection matrix and rendering resolutions associated with a plurality of areas partitioned based on a target gaze point, and rendering all pixel points associated with the first group to be rendered to a second display interface of a right-eye camera based on the second projection matrix and rendering resolutions associated with a plurality of areas partitioned based on a target gaze point;
for at least one second group to be rendered having a depth value greater than a preset depth threshold, rendering all pixel points associated with the second group to be rendered to a first display interface corresponding to a left-eye camera based on the first projection matrix and rendering resolutions associated with a plurality of areas partitioned based on a target gaze point, to obtain a rendering result;
determining a rendering content corresponding to a right-eye camera based on the rendering result and depth graphs associated with respective Gaussian spheres in the second group to be rendered;
rendering the rendering content to a second display interface corresponding to a right-eye camera.

According to one or more embodiments of the present disclosure, the determining the rendering content corresponding to a right-eye camera based on the rendering result and depth graphs associated with respective Gaussian spheres in the second group to be rendered includes:
constructing a tessellated grid aligned with the second display interface;
performing a depth shift operation on the tessellated grid based on depth graphs associated with the respective Gaussian spheres to obtain a shifted grid;
rendering the rendering result as a texture image to the shifted grid to obtain the rendering content.

In a second aspect, according to one or more embodiments of the present disclosure, there is provided an apparatus for content rendering, including:
an obtaining module configured to obtain a point cloud group to be rendered, the point cloud group including a plurality of Gaussian spheres characterizing a three-dimensional Gaussian distribution;
a determining module configured to determine, for respective Gaussian spheres, a projection matrix of the Gaussian spheres in a binocular camera coordinate system corresponding to a virtual reality device, the projection matrix being used for characterizing a projection area of the Gaussian spheres on a screen space corresponding to the virtual reality device;
a processing module configured to determine, for respective pixel points in the projection area, a target area in the screen space corresponding to the pixel points, wherein the screen space includes a plurality of areas partitioned based on a target gaze point and the areas include a gaze area and at least one edge area, the edge area having a rendering resolution less than the gaze area;
a calculating module configured to determine attenuation coefficients of the Gaussian spheres in the target area based on a rendering resolution corresponding to the target area, a rendering resolution corresponding to the gaze area and the projection matrix;
a rendering module configured to determine rendering parameters of the pixel points according to the attenuation coefficients and color information corresponding to the Gaussian spheres, and performing a rendering operation on the pixel points based on the rendering parameters.

According to one or more embodiments, the apparatus further includes:
a determining module configured to determine a current target gaze point;
a drawing module configured to draw, in the screen space, a preset number of concentric circles with the target gaze point as center;
a processing module configured to determine a concentric circle at the center position as the gaze area and determine at least one concentric circle outside the gaze area as at least one edge area;
a setting module configured to set rendering resolutions for the gaze area and the at least one edge area based on preset partition parameters.

According to one or more embodiments of the present disclosure, the determining module is configured to:
identify an eye movement feature of a user through a preset eye movement tracking technique;
determine a current gaze point of the user based on the eye movement feature and determine the current gaze point of the user as the target gaze point;
or,
determine a center area of the screen space and determine the center area as the target gaze point.

According to one or more embodiments of the present disclosure, the rendering parameters include opacity and rendering color;
The rendering module is configured to:
determine opacity corresponding to the pixel points according to the attenuation parameters and a preset opacity algorithm;
obtain rendering colors corresponding to the pixel points by multiplying color information corresponding to the Gaussian spheres by the opacity;
perform a rendering operation on the pixel points based on the opacity and the rendering color.

According to one or more embodiments of the present disclosure, the apparatus further includes:
a determining module configured to determine depth values of respective Gaussian spheres in the point cloud group and grouping the plurality of Gaussian spheres corresponding to the point cloud group based on the depths values of the respective Gaussian spheres and a preset grouping condition, to obtain a plurality of groups to be rendered;
a processing module configured to determine a rendering sequence corresponding to respective groups to be rendered by the depth values in an ascending order;
a rendering module configured to perform rendering operations on the groups to be rendered according to the rendering sequence.

According to one or more embodiments of the present disclosure, the rendering module is configured to:
determine a current group to be rendered, perform a rendering operation on the current group to be rendered via a preset sub-channel and store a rendering result to a preset storage path, wherein the rendering result at least includes opacity of pixel points corresponding to respective Gaussian spheres in the group to be rendered and the storage path includes all rendering results corresponding to already rendered groups to be rendered;
perform an opacity test operation based on all rendering results in the storage path to obtain a test result, wherein the test result includes an accumulated opacity of respective pixel points corresponding to already rendered groups to be rendered;
obtain a next group to be rendered according to the rendering sequence; and determine, for each pixel point associated with Gaussian spheres in the next group to be rendered, whether an accumulated opacity of rendered pixel points at positions associated with the pixel point reaches a preset threshold based on the test result;
if the accumulated opacity associated with the pixel point reaches a preset threshold, stop performing the rendering operations on the pixel point;
if the accumulated depth value associated with the pixel point fails to reach a preset threshold, or the pixel point is not associated with an accumulated opacity, perform the rendering operations on the pixel point based on the rendering parameters.

According to one or more embodiments of the present disclosure, the binocular camera includes a left-eye camera and a right-eye camera.

The determining module is configured to:
determine a first projection matrix of the Gaussian spheres in a left-eye camera coordinate system and determine a second projection matrix of the Gaussian spheres in a right-eye camera coordinate system.

According to one or more embodiments of the present disclosure, the apparatus further includes:
a rendering module provided for: for at least one first group to be rendered having a depth value less than a preset depth threshold, rendering all pixel points associated with the first group to be rendered to a first display interface corresponding to a left-eye camera based on the first projection matrix and rendering resolutions associated with a plurality of areas partitioned based on a target gaze point, and rendering all pixel points associated with the first group to be rendered to a second display interface of a right-eye camera based on the second projection matrix and rendering resolutions associated with a plurality of areas partitioned based on a target gaze point.

The rendering module is further configured to: for at least one second group to be rendered having a depth value greater than a preset depth threshold, render all pixel points associated with the second group to be rendered to a first display interface corresponding to a left-eye camera based on the first projection matrix and rendering resolutions associated with a plurality of areas partitioned based on a target gaze point, to obtain a rendering result.

The determining module is configured to determine a rendering content corresponding to a right-eye camera based on the rendering result and depth graphs associated with respective Gaussian spheres in the second group to be rendered.

The rendering module is further configured to render the rendering content to a second display interface corresponding to a right-eye camera.

According to one or more embodiments of the present disclosure, the determining module is configured to:
construct a tessellated grid aligned with the second display interface;
perform a depth shift operation on the tessellated grid based on depth graphs associated with the respective Gaussian spheres to obtain a shifted grid;
render the rendering result as a texture image to the shifted grid to obtain the rendering content.

In a third aspect, according to one or more embodiments of the present disclosure, there is provided an electronic device, including: a processor and a memory;
wherein the memory is stored with computer-executable instructions;
the processor executes computer-executable instructions stored in the memory, such that the processor performs the method for content rendering according to the above first aspect and various possible designs of the first aspect.

In a fourth aspect, according to one or more embodiments of the present disclosure, there is provided a computer-readable storage medium stored with computer-executable instructions therein, wherein the computer-executable instructions, when executed by a processor, implement the method for content rendering according to the above first aspect and various possible designs of the first aspect.

In a fifth aspect, according to one or more embodiments of the present disclosure, there is provided a computer program product including a computer program, wherein the computer program, when executed by a processor, implements the method for content rendering according to the above first aspect and various possible designs of the first aspect.

The above description only explains the preferred embodiments of the present disclosure and the technical principles applied. Those skilled in the art should understand that the scope of the present disclosure is not limited to the technical solution resulted from particular combinations of the above technical features, and meanwhile should also encompass other technical solutions formed from any combinations of the above technical features or equivalent features without deviating from the above disclosed inventive concept, such as the technical solutions formed by substituting the above features with the technical features disclosed here with similar functions.

Furthermore, although the respective operations are depicted in a particular order, it should be appreciated that the operations are not required to be completed in the particular order or in succession. In some cases, multitasking or multiprocessing is also beneficial. Likewise, although the above discussion includes some particular implementation details, they should not be interpreted as limitations over the scope of the present disclosure. Some features described separately in the context of the embodiments of the description can also be integrated and implemented in a single embodiment. Conversely, all kinds of features described in the context of a single embodiment can also be separately implemented in multiple embodiments or any suitable sub-combinations.

Although the subject matter is already described by languages specific to structural features and/or method logic acts, it is to be appreciated that the subject matter defined in the attached claims is not limited to the above described particular features or acts. On the contrary, the above described particular features and acts are only example forms for implementing the claims.

I/We claim:

1. A method for content rendering, characterized in comprising:
obtaining a point cloud group to be rendered, the point cloud group comprising a plurality of Gaussian spheres characterizing a three-dimensional Gaussian distribution;
for respective Gaussian spheres, determining a projection matrix of the Gaussian spheres in a binocular camera coordinate system corresponding to a virtual reality device, the projection matrix being used for characterizing a projection area of the Gaussian spheres on a screen space corresponding to the virtual reality device;
for respective pixel points in the projection area, determining a target area in the screen space corresponding to the pixel points, wherein the screen space comprises a plurality of areas partitioned based on a target gaze point and the areas comprise a gaze area and at least one edge area, the edge area having a rendering resolution less than the gaze area;
determining attenuation coefficients of the Gaussian spheres in the target area based on a rendering resolution corresponding to the target area, a rendering resolution corresponding to the gaze area and the projection matrix;
determining rendering parameters of the pixel points according to the attenuation coefficients and color information corresponding to the Gaussian spheres, and performing a rendering operation on the pixel points based on the rendering parameters.

2. The method of claim 1, wherein before determining, for the respective pixel points in the projection area, the target area in the screen space corresponding to the pixel points, the method further comprises:
determining a current target gaze point;
drawing, in the screen space, a preset number of concentric circles with the target gaze point as center;
determining a concentric circle at the center position as the gaze area and determining at least one concentric circle outside the gaze area as at least one edge area;
setting rendering resolutions for the gaze area and the at least one edge area based on preset partition parameters.

3. The method of claim 2, wherein determining the current target gaze point comprises:
identifying an eye movement feature of a user through a preset eye movement tracking technique;
determining a current gaze point of the user based on the eye movement feature and determining the current gaze point of the user as the target gaze point;
or
determining a center area of the screen space and determining the center area as the target gaze point.

4. The method of claim 1, wherein the rendering parameters comprise opacity and rendering color;
wherein determining the rendering parameters of the pixel points according to the attenuation coefficients and the color information corresponding to the Gaussian spheres, and performing the rendering operation on the pixel points based on the rendering parameters comprises:
determining opacity corresponding to the pixel points according to the attenuation parameters and a preset opacity algorithm;
obtaining rendering colors corresponding to the pixel points by multiplying color information corresponding to the Gaussian spheres by the opacity;
performing the rendering operation on the pixel points based on the opacity and the rendering color.

5. The method of claim 1, wherein the method further comprises:
determining depth values of the respective Gaussian spheres in the point cloud group and grouping the plurality of Gaussian spheres corresponding to the point cloud group based on the depths values of the respective Gaussian spheres and a preset grouping condition to obtain a plurality of groups to be rendered;
determining a rendering sequence corresponding to respective groups to be rendered by the depth values in an ascending order;
performing rendering operations on the groups to be rendered according to the rendering sequence.

6. The method of claim 5, wherein performing the rendering operations on the groups to be rendered according to the rendering sequence comprises:
determining a current group to be rendered, performing a rendering operation on the current group to be rendered via a preset sub-channel and storing a rendering result to a preset storage path, wherein the rendering result at least comprises opacity of pixel points corresponding to respective Gaussian spheres in the group to be rendered and the storage path comprises all rendering results corresponding to already rendered groups to be rendered;
performing an opacity test operation based on all rendering results in the storage path to obtain a test result, wherein the test result comprises an accumulated opacity of respective pixel points corresponding to already rendered groups to be rendered;
obtaining a next group to be rendered according to the rendering sequence, and determining, for each pixel point associated with Gaussian spheres in the next group to be rendered, whether an accumulated opacity of rendered pixel points at positions associated with the pixel point reaches a preset threshold based on the test result;
in response to the accumulated opacity associated with the pixel point reaching the preset threshold, stopping performing the rendering operations on the pixel point;
in response to the accumulated depth value associated with the pixel point failing to reach a preset threshold, or the pixel point not being associated with an accumulated opacity, performing the rendering operations on the pixel point based on the rendering parameters.

7. The method of claim 5, wherein the binocular camera comprises a left-eye camera and a right-eye camera;
wherein determining the projection matrix of the Gaussian spheres in the binocular camera coordinate system corresponding to the virtual reality device comprises:
determining a first projection matrix of the Gaussian spheres in a left-eye camera coordinate system and determining a second projection matrix of the Gaussian spheres in a right-eye camera coordinate system.

8. The method of claim 7, wherein after determining the first projection matrix of the Gaussian spheres in the left-eye camera coordinate system and determining the second projection matrix of the Gaussian spheres in the right-eye camera coordinate system, the method further comprises:
for at least one first group to be rendered having a depth value less than a preset depth threshold, rendering all pixel points associated with the first group to be rendered to a first display interface corresponding to the left-eye camera based on the first projection matrix and rendering resolutions associated with a plurality of areas partitioned based on a target gaze point, and rendering all pixel points associated with the first group to be rendered to a second display interface of the right-eye camera based on the second projection matrix and rendering resolutions associated with a plurality of areas partitioned based on a target gaze point;
for at least one second group to be rendered having a depth value greater than the preset depth threshold, rendering all pixel points associated with the second group to be rendered to a first display interface corresponding to the left-eye camera based on the first projection matrix and rendering resolutions associated with a plurality of areas partitioned based on a target gaze point, to obtain a rendering result;
determining a rendering content corresponding to the right-eye camera based on the rendering result and depth graphs associated with respective Gaussian spheres in the second group to be rendered;
rendering the rendering content to the second display interface corresponding to the right-eye camera.

9. The method of claim 8, wherein determining the rendering content corresponding to the right-eye camera based on the rendering result and the depth graphs associated with the respective Gaussian spheres in the second group to be rendered comprises:
constructing a tessellated grid aligned with the second display interface;
performing a depth shift operation on the tessellated grid based on depth graphs associated with the respective Gaussian spheres to obtain a shifted grid;
rendering the rendering result as a texture image to the shifted grid to obtain the rendering contents.

10. An electronic device comprising a processor and a memory, wherein the memory stores computer-executable instructions, when executed by the processor, cause the processor to:
obtain a point cloud group to be rendered, the point cloud group comprising a plurality of Gaussian spheres characterizing a three-dimensional Gaussian distribution;
for respective Gaussian spheres, determine a projection matrix of the Gaussian spheres in a binocular camera coordinate system corresponding to a virtual reality device, the projection matrix being used for characterizing a projection area of the Gaussian spheres on a screen space corresponding to the virtual reality device;
for respective pixel points in the projection area, determine a target area in the screen space corresponding to the pixel points, wherein the screen space comprises a plurality of areas partitioned based on a target gaze point and the areas comprise a gaze area and at least one edge area, the edge area having a rendering resolution less than the gaze area;
determine attenuation coefficients of the Gaussian spheres in the target area based on a rendering resolution corresponding to the target area, a rendering resolution corresponding to the gaze area and the projection matrix;
determine rendering parameters of the pixel points according to the attenuation coefficients and color information corresponding to the Gaussian spheres, and perform a rendering operation on the pixel points based on the rendering parameters.

11. The electronic device of claim 10, wherein before determining, for the respective pixel points in the projection area, the target area in the screen space corresponding to the pixel points, the processor is further caused to:
determine a current target gaze point;
draw, in the screen space, a preset number of concentric circles with the target gaze point as center;
determine a concentric circle at the center position as the gaze area and determining at least one concentric circle outside the gaze area as at least one edge area;
set rendering resolutions for the gaze area and the at least one edge area based on preset partition parameters.

12. The electronic device of claim 11, wherein the computer-executable instructions that cause to processor to determine the current target gaze point comprise instructions to cause the processor:
identify an eye movement feature of a user through a preset eye movement tracking technique;
determine a current gaze point of the user based on the eye movement feature and determine the current gaze point of the user as the target gaze point;
or
determine a center area of the screen space and determine the center area as the target gaze point.

13. The electronic device of claim 10, wherein the rendering parameters comprise opacity and rendering color;
wherein the computer-executable instructions that cause to processor to determine the rendering parameters of the pixel points according to the attenuation coefficients and the color information corresponding to the Gaussian spheres, and perform the rendering operation on the pixel points based on the rendering parameters comprise instructions to cause the processor:
determine opacity corresponding to the pixel points according to the attenuation parameters and a preset opacity algorithm;
obtain rendering colors corresponding to the pixel points by multiplying color information corresponding to the Gaussian spheres by the opacity;
perform the rendering operation on the pixel points based on the opacity and the rendering color.

14. The electronic device of claim 10, wherein the processor is further caused to:
determine depth values of the respective Gaussian spheres in the point cloud group and group the plurality of Gaussian spheres corresponding to the point cloud group based on the depths values of the respective Gaussian spheres and a preset grouping condition to obtain a plurality of groups to be rendered;
determine a rendering sequence corresponding to respective groups to be rendered by the depth values in an ascending order;
perform rendering operations on the groups to be rendered according to the rendering sequence.

15. The electronic device of claim 14, wherein the instructions that cause to processor to perform the rendering operations on the groups to be rendered according to the rendering sequence comprise instructions to cause the processor:
determine a current group to be rendered, perform a rendering operation on the current group to be rendered via a preset sub-channel and store a rendering result to a preset storage path, wherein the rendering result at least comprises opacity of pixel points corresponding to respective Gaussian spheres in the group to be rendered and the storage path comprises all rendering results corresponding to already rendered groups to be rendered;
perform an opacity test operation based on all rendering results in the storage path to obtain a test result, wherein the test result comprises an accumulated opacity of respective pixel points corresponding to already rendered groups to be rendered;
obtain a next group to be rendered according to the rendering sequence, and determine, for each pixel point associated with Gaussian spheres in the next group to be rendered, whether an accumulated opacity of rendered pixel points at positions associated with the pixel point reaches a preset threshold based on the test result;
in response to the accumulated opacity associated with the pixel point reaching the preset threshold, stop performing the rendering operations on the pixel point;
in response to the accumulated depth value associated with the pixel point failing to reach a preset threshold, or the pixel point not being associated with an accumulated opacity, perform the rendering operations on the pixel point based on the rendering parameters.

16. The electronic device of claim 14, wherein the binocular camera comprises a left-eye camera and a right-eye camera;
wherein the instructions that cause to processor to determine the projection matrix of the Gaussian spheres in the binocular camera coordinate system corresponding to the virtual reality device comprise instructions to cause the processor:
determine a first projection matrix of the Gaussian spheres in a left-eye camera coordinate system and determine a second projection matrix of the Gaussian spheres in a right-eye camera coordinate system.

17. The electronic device of claim 16, wherein after determining the first projection matrix of the Gaussian spheres in the left-eye camera coordinate system and determining the second projection matrix of the Gaussian spheres in the right-eye camera coordinate system, the processor is further caused to:
for at least one first group to be rendered having a depth value less than a preset depth threshold, render all pixel points associated with the first group to be rendered to a first display interface corresponding to the left-eye camera based on the first projection matrix and rendering resolutions associated with a plurality of areas partitioned based on a target gaze point, and render all pixel points associated with the first group to be rendered to a second display interface of the right-eye camera based on the second projection matrix and rendering resolutions associated with a plurality of areas partitioned based on a target gaze point;
for at least one second group to be rendered having a depth value greater than the preset depth threshold, render all pixel points associated with the second group to be rendered to a first display interface corresponding to the left-eye camera based on the first projection matrix and rendering resolutions associated with a plurality of areas partitioned based on a target gaze point, to obtain a rendering result;
determine a rendering content corresponding to the right-eye camera based on the rendering result and depth graphs associated with respective Gaussian spheres in the second group to be rendered;
render the rendering content to the second display interface corresponding to the right-eye camera.

18. The electronic device of claim 17, wherein the instructions that cause to processor to determine the rendering content corresponding to the right-eye camera based on the rendering result and the depth graphs associated with the respective Gaussian spheres in the second group to be rendered comprise instructions to cause the processor:
construct a tessellated grid aligned with the second display interface;
perform a depth shift operation on the tessellated grid based on depth graphs associated with the respective Gaussian spheres to obtain a shifted grid;
render the rendering result as a texture image to the shifted grid to obtain the rendering contents.

19. A non-transitory computer-readable storage medium having computer-executable instructions stored therein, wherein the computer-executable instructions, when executed by a processor, cause the processor to:
obtain a point cloud group to be rendered, the point cloud group comprising a plurality of Gaussian spheres characterizing a three-dimensional Gaussian distribution;
for respective Gaussian spheres, determine a projection matrix of the Gaussian spheres in a binocular camera coordinate system corresponding to a virtual reality device, the projection matrix being used for characterizing a projection area of the Gaussian spheres on a screen space corresponding to the virtual reality device;
for respective pixel points in the projection area, determine a target area in the screen space corresponding to the pixel points, wherein the screen space comprises a plurality of areas partitioned based on a target gaze point and the areas comprise a gaze area and at least one edge area, the edge area having a rendering resolution less than the gaze area;
determine attenuation coefficients of the Gaussian spheres in the target area based on a rendering resolution corresponding to the target area, a rendering resolution corresponding to the gaze area and the projection matrix;
determine rendering parameters of the pixel points according to the attenuation coefficients and color information corresponding to the Gaussian spheres, and perform a rendering operation on the pixel points based on the rendering parameters.

20. The non-transitory computer-readable storage medium of claim 19, wherein before determining, for the respective pixel points in the projection area, the target area in the screen space corresponding to the pixel points, the processor is further caused to:
determine a current target gaze point;
draw, in the screen space, a preset number of concentric circles with the target gaze point as center;
determine a concentric circle at the center position as the gaze area and determining at least one concentric circle outside the gaze area as at least one edge area;
set rendering resolutions for the gaze area and the at least one edge area based on preset partition parameters.
